(19) United States
(12) Patent Application Publication
(10) Pub. No.: US 2010/0060416 A1
(43) Pub. Date: Mar. 11, 2010

(54) Operating instruction receiving apparatus

(75) Inventor: Masaki Watanabe, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/458,350

(22) Filed: Jul. 8, 2009

(30) Foreign Application Priority Data
Sep. 5, 2008 (JP) 2008-228191

(51) Int. Cl. G06F 7/04; G05B 23/00; G08B 29/00

(52) U.S. Cl. 340/5.82; 382/115

(57) ABSTRACT

A disclosed operating instruction receiving apparatus includes multiple biometric authentication sensors, with which multiple operating instruction options are associated; a matching operation unit configured to, when biometric information of a user is detected by one of the biometric authentication sensors, perform a matching operation in which the detected biometric information is compared with registered user biometric information to specify the user; and a determining unit configured to, if the detected biometric information matches the registered user biometric information, determine an operating instruction option associated with the one of the biometric authentication sensors as an operating instruction.

### CROSS-REFERENCE TO RELATED APPLICATIONS

This application is based upon and claims the benefit of priority of Japanese Patent Application 2008-228191, filed on Sep. 5, 2008, the entire contents of which are incorporated herein by reference.

FIELD

The present disclosure is directed to an operating instruction receiving apparatus used, for example, for controlling an elevator to make stops at floors.

### BACKGROUND

Patent Document 1 discloses a system for safety checking or a system for transporting a user by a lift.

That is, according to the first embodiment of the disclosed system, verification code that is used to determine a user by matching his/her fingerprint or the like using a mobile verification device is generated and then transmitted to a recognition device fixed on an elevator. A matching device connected to the recognition device compares the verification code with registered data of the user, and if they match, the matching device acquires a destination predetermined for the user. Subsequently, the matching device checks the registered data to determine whether the user is allowed to access the destination, and if it is affirmatively determined, the user is transported to the destination.

According to the second embodiment of the disclosed system, verification code that determines a user by matching his/her fingerprint or the like using a mobile verification device is generated and then transmitted to a recognition device fixed on an elevator. The user also inputs a destination to the verification device. A matching device connected to the recognition device compares the verification code with registered data of the user. If they match, the matching device then checks the registered data to determine whether the user is allowed to access the destination. If it is affirmatively determined, the user is transported to the destination.

On the other hand, Patent Document 2 discloses a mobile phone which allows a user to register frequently-used functions with the mobile phone so that the user is able to activate a registered function with a simple operation. That is, the mobile phone has a fingerprint identification sensor which recognizes fingerprints from multiple fingers. The mobile phone registers these fingerprints in association with specific functions so that, when a fingerprint is matched, a function associated with the fingerprint is executed.

Patent Document 3 discloses an information processing device that provides a touch panel, thereby achieving comfortable mouse emulation. The information processing device allows a user to perform a touch panel input with more natural usability. That is, multiple positions on the touch panel touched by the user are detected by sensors, and the touched positions and individual pieces of predetermined information (corresponding to each of the touched positions or the sensors) are recognized. The recognized pieces of the predetermined information are made associated with input signals (options).

Patent Document 4 discloses a device for inputting text by key operation on a numeric keypad of an electronic device. That is, a sensor is provided behind an individual key of the keypad so as to determine a position of a user's finger on the key. By evaluating the position (sensor output), the position is assigned to a possible input option.

[Patent Document 1] Japanese Laid-open Patent Application Publication No. 2004-352502

[Patent Document 2] Japanese Laid-open Patent Application Publication No. 2005-268951

[Patent Document 3] Japanese Laid-open Patent Application Publication No. 2002-55781

[Patent Document 4] Japanese Laid-open Patent Application Publication No. 2005-527018

The first embodiment taken from the Patent Document 1 leaves the problem that users cannot select a destination since it is already predetermined for each user. The second embodiment requires a user to perform two operational steps of the fingerprint verification and destination input, resulting in a burdensome operation.

On the other hand, according to Patent Document 2, only one operation can be selected with one finger, which does not enable making versatile operating instructions.

The technologies of Patent Documents 3 and 4 cannot be used for operating instructions that require security since the accuracy of the selection is not assessed.

### SUMMARY

One embodiment of the present disclosure is an operating instruction receiving apparatus that includes multiple biometric authentication sensors, with which multiple operating instruction options are associated; a matching operation unit configured to, when biometric information of a user is detected by one of the biometric authentication sensors, perform a matching operation in which the detected biometric information is compared with registered user biometric information to specify the user; and a determining unit configured to, if the detected biometric information matches the registered user biometric information, determine an operating instruction option associated with the one of the biometric authentication sensors as an operating instruction.

Another embodiment of the present disclosure is an operating instruction receiving method including the steps of performing a matching operation if biometric information of a user is detected by one of multiple biometric authentication sensors, with which multiple operating instruction options are associated, the detected biometric information being compared, in the matching operation, with registered user biometric information to specify the user; and determining, if the detected biometric information matches the registered user biometric information, an operating instruction option associated with the one of the biometric authentication sensors as an operating instruction.

The object and advantages of the disclosure will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 shows a structural example of one embodiment in which the present disclosure is applied to controlling an elevator to make stops at floors;

FIG. 2 shows a first example of an operation panel;

FIG. 3 shows a second example of the operation panel;

FIG. 4 shows a third example of the operation panel;

FIG. 5 shows an example of capture detection obtained in area divisions;

FIGS. 6A through 6C show examples of various types of information held by a registered information storage unit;

FIGS. 7A through 7C show examples of various types of information held by a data holding unit of a floor number/floor-number specifying user check unit;

FIG. 8 is a flowchart showing a first process example of the embodiment; and

FIG. 9 is a flowchart showing a second process example of the embodiment.

### DESCRIPTION OF EMBODIMENTS

An embodiment that describes the best mode for carrying out the present invention is explained next with reference to the drawings.

### [Structure]

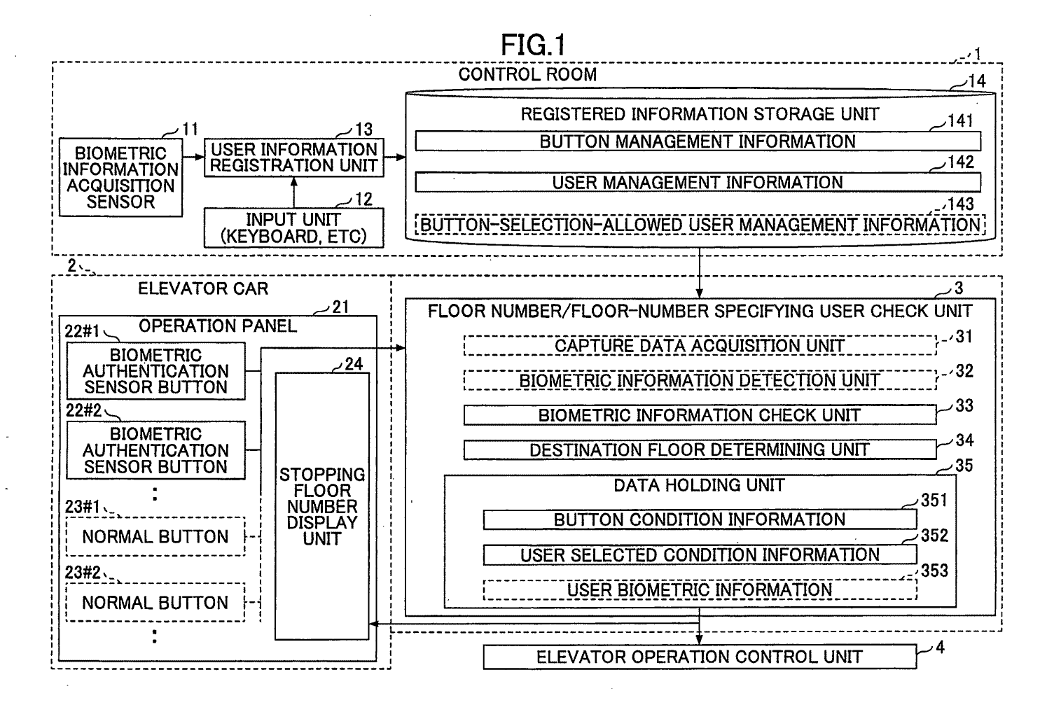

FIG. 1 shows a structural example of one embodiment in which the present disclosure is applied to controlling an elevator to make stops at floors. That is, the present disclosure is applied to an elevator which allows only certain people to specify stops at predetermined floors. It should be understood that the present disclosure is applicable other than elevators.

With reference to FIG. 1, a control room 1 includes a biometric information acquisition sensor 11, an input unit 12, a user information registration unit 13 and a registered information storage unit 14.

The biometric information acquisition sensor 11 acquires information which is used as pre-registration biometric information in the matching operation. As the biometric information, various types can be used, such as fingerprints and palm vein patterns.

The input unit 12 includes a keyboard, a mouse and the like, and is used to input a user name, a stopping floor and the like, as well as to perform registration.

The user information registration unit 13 registers user information with a registered information storage unit 14 based on the biometric information input from the biometric information acquisition sensor 11 and information input from the input unit 12.

The registered information storage unit 14 is an information recording medium, such as a HDD (Hard Disk Drive). Information registered in the registered information storage unit 14 includes button management information 141, user management information 142 and button-selection-allowed user management information 143. Each information item is described later. The button-selection-allowed user management information 143 is created by integrating the button management information 141 and the user management information 142. Although the button-selection-allowed user management information 143 is provided to improve a subsequent processing operation, it may be omitted.

The input unit 12, the user information registration unit 13 and the registered information storage unit 14 may be implemented by a PC (personal computer) or the like.

In an elevator car 2, an operation panel 21 is provided to allow users to input stopping floors or the like. The operation panel 21 includes biometric authentication sensor buttons 22#1, 22#2, . . . , normal buttons 23#1, 23#2, . . . , and a stopping floor number display unit 24.

The biometric authentication sensor buttons 22#1, 22#2, . . . are buttons each having the function of a biometric authentication sensor.

The normal buttons 23#1, 23#2, . . . are mechanical or static switches. If all buttons on the operation panel 21 are implemented by biometric authentication sensor buttons 22#1, 22#2, . . . , the normal buttons 23#1, 23#2, . . . are not necessary.

The stopping floor number display unit 24 displays a selected stopping floor, and is implemented by lamps or the like provided around or near buttons. Alternatively, the stopping floor number display unit 24 displays a selected stopping floor with a number.

A floor number/floor-number specifying user check unit 3 performs a main control operation of receiving a stopping floor. The floor number/floor-number specifying user check unit 3 may be provided in or outside the elevator car 2.

The floor number/floor-number specifying user check unit 3 includes a capture data acquisition unit 31, a biometric information detection unit 32, a biometric information check unit 33, a destination floor determining unit 34 and a data holding unit 35. The floor number/floor-number specifying user check unit 3 inputs signals from the biometric authentication sensor button 22#1, 22#2, . . . and the normal button 23#1, 23#2, . . . of the operation panel 21, and outputs control signals to the stopping floor number display unit 24 and an elevator operation control unit 4. The elevator operation control unit 4 controls up and down movement of the elevator car 2, opening and closing of the door, and the like.

The capture data acquisition unit 31 has a function of acquiring capture data, such as fingerprint images or palm vein images, from the biometric authentication sensor buttons 22#1, 22#2, . . . .

The biometric information detection unit 32 has a function of detecting biometric information from the capture data obtained by the capture data acquisition unit 31, which biometric information is used in the matching operation. Note that if the capture data acquisition and the biometric information detection are performed by the biometric authentication sensor buttons 22#1, 22#2, . . . , the capture data acquisition unit 31 and the biometric information detection unit 32 may be omitted.

The biometric information check unit 33 has a function of comparing the biometric information detected by the biometric information detection unit 32 with the pre-registered biometric information.

The destination floor determining unit 34 has a function of determining a floor based on the matching result obtained by the biometric information check unit 33 or the selection made on the normal button 23#1, 23#2, or . . . .

The data holding unit 35 holds information necessary for processing operations. Information held by the data holding unit 35 includes button condition information 351, user selected condition information 352 and user biometric information 353. Each information item is described later. Note that if biometric information is acquired from the user management information 142 of the registered information storage unit 14 each time of the matching operation, the user biometric information 353 may be omitted.

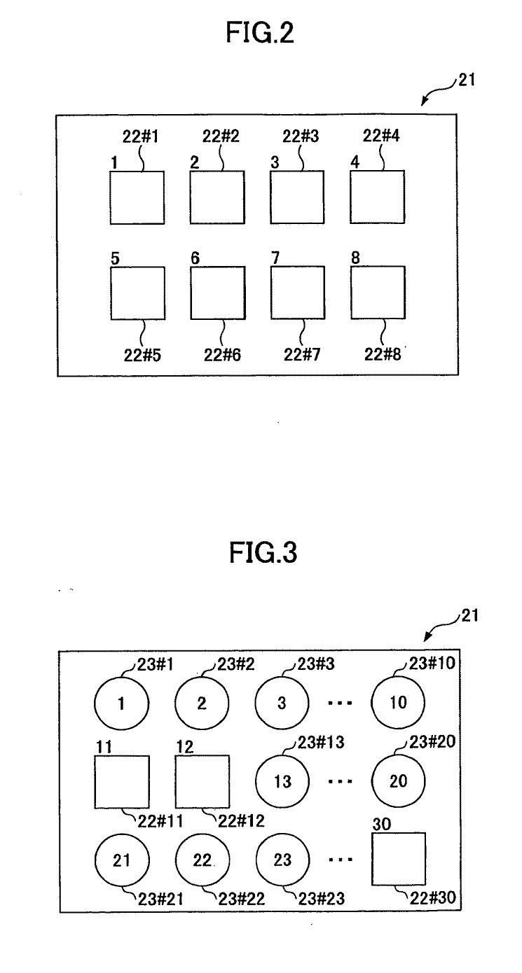

FIG. 2 shows an example of the operation panel 21. In this example, all buttons used for indicating floor numbers are implemented by the biometric authentication sensor buttons 22#1-22#8.

FIG. 3 shows another example of the operation panel 21. In this example, buttons corresponding to floors that require user authentication are implemented by biometric authentication sensor buttons 22#11, 22#12, 22#30, while buttons corresponding to floors that do not require user authentication are implemented by normal buttons 23#1-23#10, 23#13-23#23, . . . . For example, in the case where some floors can be accessed only by VIPs (very important persons), biometric authentication sensor buttons are used as buttons for specifying such floors.

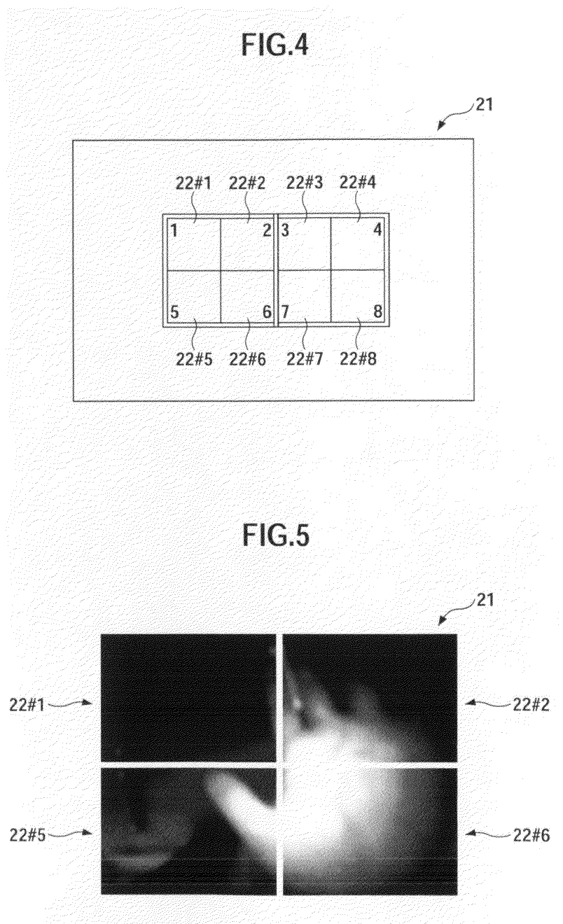

FIG. 4 shows another example of the operation panel 21. In this example, multiple buttons are provided by dividing sensory regions of individual biometric authentication sensor parts. That is, the sensor plane of the left-hand biometric authentication sensor part is divided into four areas to provide biometric authentication sensor buttons 22#1, 22#2, 22#5 and 22#6, and the sensor plane of the right-hand biometric authentication sensor part is divided into four areas to provide biometric authentication sensor buttons 22#3, 22#4, 22#7 and 22#8. FIG. 5 shows an example of capture detection obtained in such area divisions (with the case of using a palm vein authentication sensor). A recorded biometric image is divided into four, and the divided image sections are treated as input images of the biometric authentication sensor buttons 22#1, 22#2, 22#5 and 22#6. Herewith, it is possible to perform an operation as in the case where the biometric authentication sensor buttons are individual biometric authentication sensors. Note that the number of divisions is not limited to four, and each biometric authentication sensor part can be divided into an arbitrary number in view of the size and the like of the biometric authentication sensor part.

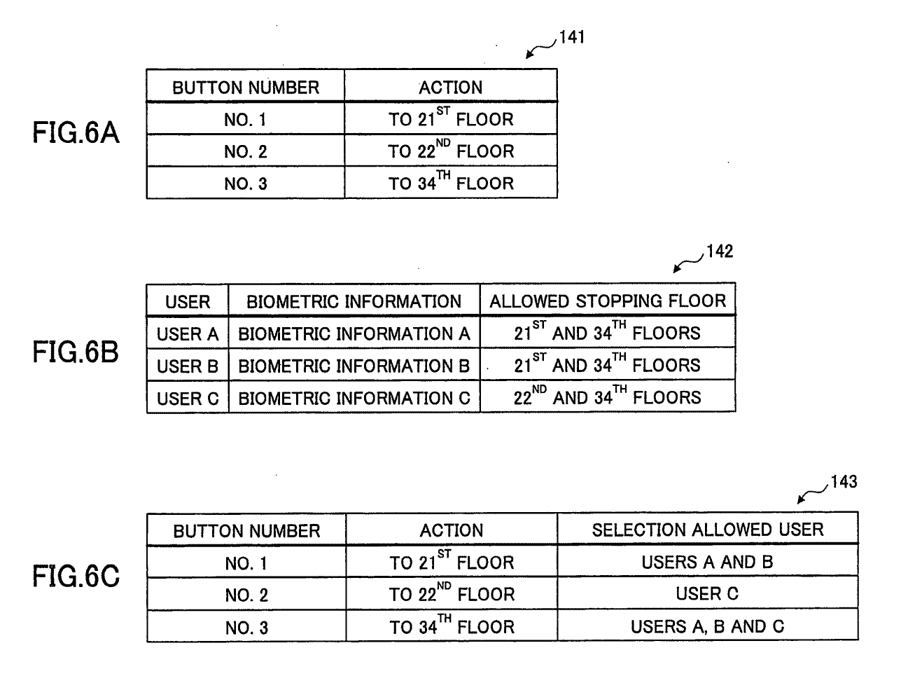

FIGS. 6A through 6C show examples of various types of information held by the registered information storage unit 14.

FIG. 6A is an example of the button management information 141, which includes “button number” that specifies a position of each biometric authentication sensor button 22 (22#1, 22#2, . . . ) on the operation panel 21; and “action” that indicates a destination floor specified when the corresponding button number is selected.

FIG. 6B is an example of the user management information 142, which includes “user” that specifies a user; “biometric information” that is biometric information of the corresponding user; and “allowed stopping floor” that indicates floors which the corresponding user is allowed to access.

FIG. 6C is an example of the button-selection-allowed user management information 143, which includes “button number” that specifies a position of each biometric authentication sensor button 22 on the operation panel 21; “action” that indicates a destination floor specified when the corresponding button number is selected; and “selection allowed user” that indicates one or more users allowed to select the corresponding destination floor. Note that the button-selection-allowed user management information 143 can be generated by sorting the user management information 142 of FIG. 6B according to the allowed stopping floors and integrating the sorted user management information 142 with the button management information 141 of FIG. 6A. In terms of the information amount, the amount of the button-selection-allowed user management information 143 does not exceed the combined amount of the button management information 141 of FIG. 6A and the user management information 142 of FIG. 6B; however, the button-selection-allowed user management information 143 is provided in order to simplify a process performed by the floor number/floor-number specifying user check unit 3 to generate the button condition information 351 (to be described later). Accordingly, in the case where the floor number/floor-number specifying user check unit 3 generates the button condition information 351 based on the button management information 141 of FIG. 6A and the user management information 142 of FIG. 6B, it is not necessary to arrange the button-selection-allowed user management information 143 in advance.

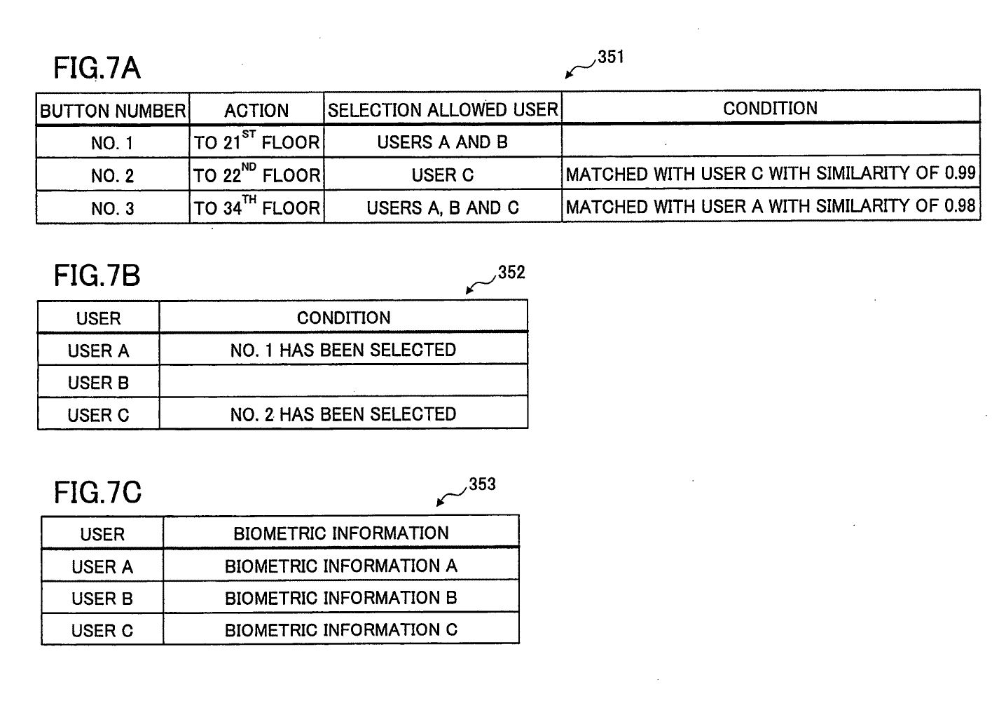

FIGS. 7A through 7C show examples of various types of information held by the data holding unit 35 of the floor number/floor-number specifying user check unit 3.

FIG. 7A is an example of the button condition information 351, which includes “button number” that specifies a position of each biometric authentication sensor button 22 on the operation panel 21; “action” that indicates a destination floor specified when the corresponding button number is selected; “selection allowed user” that indicates one or more users allowed to select the corresponding destination floor; and “condition” that indicates a result of the authentication made with respect to the corresponding button. That is, the button condition information 351 has a structure in which the item “condition” is added to the button-selection-allowed user management information 143 of FIG. 6C. Therefore, in the case where the button-selection-allowed user management information 143 can be obtained, the initial data of the button condition information 351 is generated simply by adding the item “condition”. If the button-selection-allowed user management information 143 cannot be obtained, the initial data of the button condition information 351 is generated from the button management information 141 and the user management information 142.

FIG. 7B shows an example of the user selection condition information 352, which includes “user” that specifies a user and “condition” that indicates a button selection condition of the corresponding user.

FIG. 7C shows an example of the user biometric information 353, which includes “user” that specifies a user and “biometric information” that is biometric information of the corresponding user. Note that, as has been mentioned above, the user biometric information 353 can be omitted if biometric information is acquired from the user management information 142 of the registered information storage unit 14 each time of the matching operation. [Operation]

With reference to FIG. 1, a pre-registration operation is performed using the biometric information acquisition sensor 11, the input unit 12 and the user information registration unit 13. Specifically, for each user who is allowed to stop the elevator at a specific floor (more than one floors can be specified), the following items are registered in the user management information 142 (FIG. 6B) of the registered information storage unit 14: biometric information of the user; and a floor number(s) at which the user is able to make a stop.

Next is described an operation of the elevator stopping floor control.

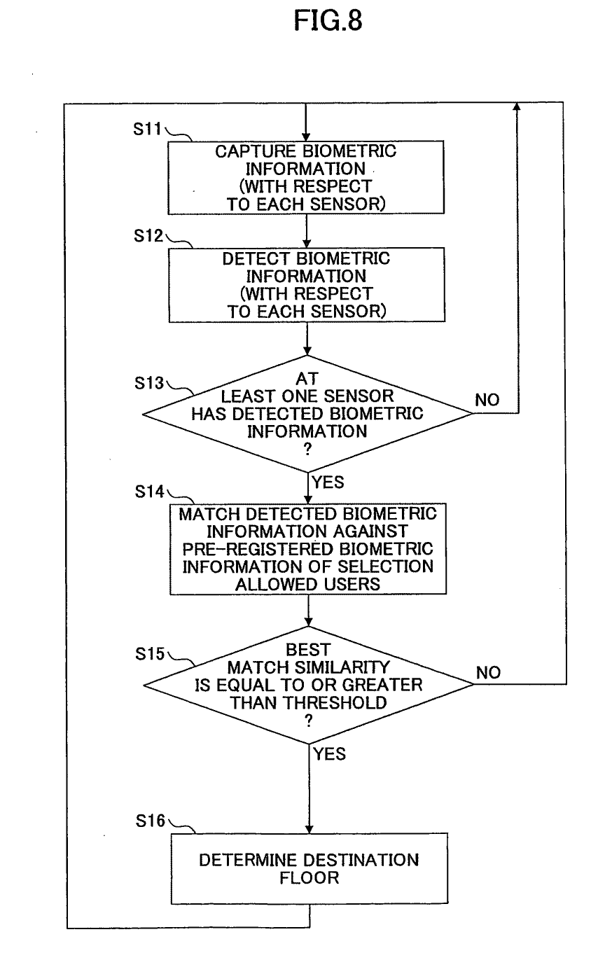

FIG. 8 is a flowchart showing a process example of the above embodiment. The process illustrated in FIG. 8 is performed when a user gets in the elevator car 2 and operates on the operation panel 21.

With reference to FIG. 8, each biometric authentication sensor button 22 captures biometric information (original information) periodically or at a time when it detects a contact with a finger or a palm in accordance with the control of the capture data acquisition unit 31 or the function of the biometric authentication sensor button 22 itself (Step S11). Specifically, a finger print of a finger placed on the sensor plane, a vein pattern of a palm held over the sensor, or the like is captured as an image. This process is performed with respect to each biometric authentication sensor button 22.

Next, in accordance with the control of the biometric information detection unit 32 or the function of the biometric authentication sensor button 22 itself, biometric information which indicates the amount of characteristic used for the matching operation is detected from the captured biometric information (original information) (Step S12).

Then, the biometric information check unit 33 determines whether at least one biometric authentication sensor button 22 has detected biometric information (Step S13). If no biometric authentication sensor button 22 has detected biometric information (NO in Step S13), the operation returns to Step S11 of the biometric information (original information) capture.

If at least one biometric authentication sensor button 22 has detected biometric information (YES in Step S13), the biometric information check unit 33 compares the detected biometric information with pre-registered biometric information of one or more selection allowed users specified in the button condition information 351 (specifically, pre-registered biometric information of one or more selection allowed users corresponding to a button number of the biometric authentication sensor button 22 which has detected the biometric information) (Step S14). The result of the matching operation is output as the matching similarity. The pre-registered biometric information of the selection allowed users is acquired from the user biometric information 353 of the data holding unit 35 or the user management information 142 of the registered information storage unit 14.

The destination floor determining unit 34 then determines whether the highest similarity (best match) is equal to or greater than a predetermined threshold (Step S15). That is, if the biometric information is acquired from one biometric authentication sensor button 22, the matching result of the biometric information is used. If the biometric information is acquired from multiple biometric authentication sensor buttons 22, the matching result of the biometric information having the highest similarity is used. If the similarity is below the predetermined threshold (NO in Step S15), the operation returns to Step S11 of the biometric information (original information) capture.

If the similarity is equal to or greater than the predetermined threshold (YES in Step S15), the destination floor determining unit 34 acquires, from the button condition information 351, an action corresponding to a button number of the biometric authentication sensor button 22 which has detected the best match biometric information, and determines a destination floor specified in the action as a selected floor (Step S16).

Note that in the case where the normal buttons 23 (23#1, 23#2, . . . ) are also provided on the operation panel 21, as in the case illustrated in FIG. 3, the destination floor determining unit 34 puts priority on selection made on a normal button 23 when determining a destination floor.

In parallel with the above-mentioned reception of the destination floor, the door of the elevator car 2 is closed by the elevator operation control unit 4. The elevator operation control unit 4 controls the elevator car 2 to move to the destination floor of the user if the destination floor has been determined when the door is closed. If the destination floor has not been determined, the reception of the destination floor is continued.

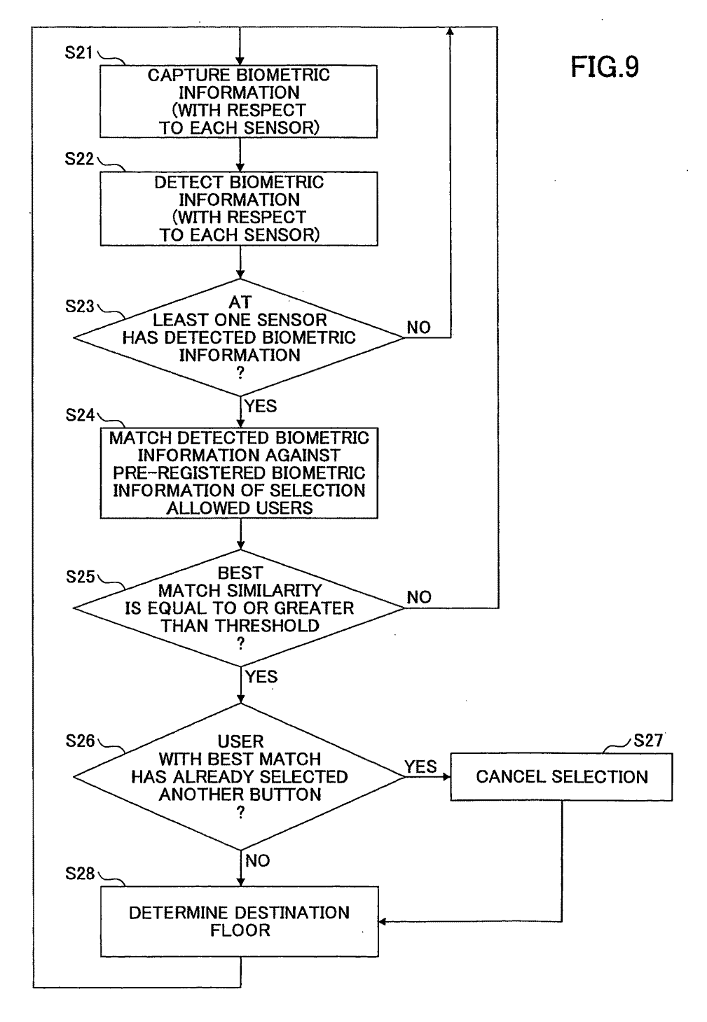

FIG. 9 is a flowchart showing another process example of the embodiment. The process illustrated in FIG. 9 allows an already selected floor to be changed to another one.

With reference to FIG. 9, each biometric authentication sensor button 22 captures biometric information (original information) periodically or at a time when it detects a contact with a finger or a palm in accordance with the control of the capture data acquisition unit 31 or the function of the biometric authentication sensor button 22 itself (Step S21). Specifically, a fingerprint of a finger placed on the sensor plane, a vein pattern of a palm held over the sensor, or the like is captured as an image. This process is performed with respect to each biometric authentication sensor button 22.

Next, in accordance with the control of the biometric information detection unit 32 or the function of the biometric authentication sensor button 22 itself, biometric information which indicates the amount of characteristic used for the matching operation is detected from the captured biometric information (original information) (Step S22).

Then, the biometric information check unit 33 determines whether at least one biometric authentication sensor button 22 has detected biometric information (Step S23). If no biometric authentication sensor button 22 has detected biometric information (NO in Step S23), the operation returns to Step S21 of the biometric information (original information) capture.

If at least one biometric authentication sensor button 22 has detected biometric information (YES in Step S23), the biometric information check unit 33 compares the detected biometric information with pre-registered biometric information of one or more selection allowed users specified in the button condition information 351 (specifically, pre-registered biometric information of one or more selection allowed users corresponding to a button number of the biometric authentication sensor button 22 which has detected the biometric information) (Step S24). The result of the matching operation is output as the matching similarity. The pre-registered biometric information of the selection allowed users is acquired from the user biometric information 353 of the data holding unit 35 or the user management information 142 of the registered information storage unit 14.

The destination floor determining unit 34 then determines whether the highest similarity (best match) is equal to or greater than a predetermined threshold (Step S25). That is, if the biometric information is acquired from one biometric authentication sensor button 22, the matching result of the biometric information is used. If the biometric information is acquired from multiple biometric authentication sensor buttons 22, the matching result of the biometric information having the highest similarity is used. If the similarity is below the predetermined threshold (NO in Step S25), the operation returns to Step S21 of the biometric information (original information) capture.

If the similarity is equal to or greater than the predetermined threshold (YES in Step S25), the destination floor determining unit 34 determines, with reference to the user selection condition information 352, whether the user with the best match has already selected another button (Step S26).

If another button has already been selected (YES in Step S26), the destination floor determining unit 34 cancels the selection (Step S27). Then, the destination floor determining unit 34 acquires an action corresponding to a button number of the biometric authentication sensor button 22 that has detected the best match biometric information and determines a destination floor specified in the action as a selected floor (Step S28).

If another button has not been selected (NO in Step S26), the destination floor determining unit 34 acquires, from the button condition information 351, an action corresponding to a button number of the biometric authentication sensor button 22 that has detected the best match biometric information and determines a destination floor specified in the action as a selected floor (Step S28).

Note that in the case where the normal buttons 23 (23#1, 23#2, . . . ) are also provided on the operation panel 21, as in the case illustrated in FIG. 3, the destination floor determining unit 34 puts priority on selection made on a normal button 23 when determining a destination floor.

In parallel with the above-mentioned reception of the destination floor, the door of the elevator car 2 is closed by the elevator operation control unit 4. The elevator operation control unit 4 controls the elevator car 2 to move to the destination floor of the user if the destination floor has been determined when the door is closed. If the destination floor has not been determined, the reception of the destination floor is continued. Even if the destination floor is determined once, the reception of a destination floor is continued until the elevator car 2 reaches the determined destination floor. If change of the destination floor is instructed while the door is closed or when the elevator car 2 is moving to the destination floor, the destination floor is changed. That is, in the case where a single user sequentially causes multiple biometric authentication sensor buttons 22 to perform the matching operation in order to compare biometric information with the pre-registered information, a floor number corresponding to a biometric authentication sensor button 22 that has most recently detected biometric information is selected as the number of a stopping floor desired by the user. Herewith, if the user selects a wrong destination floor by mistake, the destination floor can be readily changed. [General Overview]

As has been described above, the present embodiment provides the following advantages: (1) the user identity verification and operating instruction reception are performed with a single user operation; and (2) correction of the operating instruction can be made with a single user operation.

Thus, the present invention has been described herein with reference to preferred embodiments thereof. While the present invention has been shown and described with particular examples, it should be understood that various changes and modification may be made to the particular examples without departing from the scope of the broad spirit and scope of the present invention as defined in the claims. That is, the scope of the present invention is not limited to the particular examples and the attached drawings.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority or inferiority of the invention. Although the embodiments of the present disclosure have been described in detail, it should be understood that various changes, substitutions, and alterations could be made hereto without departing from the spirit and scope of the invention.

What is claimed is:

1. An operating instruction receiving apparatus comprising:
a plurality of biometric authentication sensors, with which a plurality of operating instruction options is associated;
a matching operation unit configured to, when biometric information of a user is detected by one of the biometric authentication sensors, perform a matching operation in which the detected biometric information is compared with registered user biometric information to specify the user; and
a determining unit configured to, if the detected biometric information matches the registered user biometric information, determine
an operating instruction option associated with the one of the biometric authentication sensors as an operating instruction.

2. The operating instruction receiving apparatus as claimed in claim 1, wherein if the operating instruction option associated with the one of the biometric authentication sensors is an operating instruction that the specified user is allowed to select, the determining unit determines the operating instruction option as the operating instruction.

3. The operating instruction receiving apparatus as claimed in claim 1, wherein a number of the biometric authentication sensors is equal to a number of the operating instruction options.

4. The operating instruction receiving apparatus as claimed in claim 1, wherein among the operating instruction options, only operating instruction options requiring identity verification are associated with the biometric authentication sensors.

5. The operating instruction receiving
apparatus as claimed in claim 1, wherein the biometric authentication sensors are divided areas of a sensory region of a biometric authentication sensor part.

6. The operating instruction receiving apparatus as claimed in claim 1, wherein the determining unit allows a change of the determined operating instruction option until an operation corresponding to the determined operating instruction option is completed.

7. The operating instruction receiving apparatus as claimed in claim 1, wherein if a plurality of pieces of the biometric information is detected by more than one of the biometric authentication sensors, the matching operation unit specifies a biometric authentication sensor that has detected a piece of the biometric information being a best match with the registered user biometric information, and the determining unit determines an operating instruction option associated with the specified biometric authentication sensor as the operating instruction.

8. The operating instruction receiving apparatus as claimed in claim 1, further comprising a display unit configured to display a selection condition of each of the biometric authentication sensors.

9. An operating instruction receiving method comprising:
performing a matching operation if biometric information of a user is detected by one of a plurality of biometric authentication sensors, with which a plurality of operating instruction options is associated, the detected biometric information being compared, in the matching operation, with registered user biometric information to specify the user; and
determining, if the detected biometric information matches the registered user biometric information, an operating instruction option associated with the one of the biometric authentication sensors as an operating instruction.

10. The operating instruction receiving method as claimed in claim 9, wherein if the operating instruction option associated with the one of the biometric authentication sensors is an operating instruction that the specified user is allowed to select, the operating instruction option is determined as the operating instruction.

11. The operating instruction receiving method as claimed in claim 9, wherein a change of the determined operating instruction option is allowed until an operation corresponding to the determined operating instruction option is completed.

12. The operating instruction receiving method as claimed in claim 9, wherein if a plurality of pieces of the biometric information is detected by more than one of the biometric authentication sensors, a biometric authentication sensor that has detected a piece of the biometric information being a best match with the registered user biometric information is specified, and an operating instruction option associated with the specified biometric authentication sensor is determined as the operating instruction.
